(19) United States
(12) Patent Application Publication
(10) Pub. No.: US 2007/0133953 A1
(43) Pub. Date: Jun. 14, 2007

(54) Backup and recovery of recorded contents

(75) Inventors: Wilhelmus Franciscus Johannes Fontijn, Eindhoven (NL); Johan Sebastiaan Henri Van Gageldonk, Eindhoven (NL); Johannis Friso Rendert Blacquiere, Eindhoven (NL); Declan Patrick Kelly, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/572,847

(22) PCT Filed: Sep. 1, 2004
(86) PCT No.: PCT/IB04/51661

§ 371 Date: Mar. 21, 2006

(30) Foreign Application Priority Data
Sep. 22, 2003 (EP) 03103476.2

(51) Int. Cl. H04N 5/00

(52) U.S. Cl. 386/126

(57) ABSTRACT

The invention relates to a content item recorder (101) comprising storage means (109) for storing a plurality of content items. The content item recorder (101) may be a Personal Video Recorder comprising a hard disk. The content item recorder (109) comprises a back-up processor (115) generating reduced reference information associated with the plurality of content items; and a memory interface (117) for storing the reduced reference information to a back-up memory (119) separate from the storage means (109). The reduced reference information may be reduced user profile information of reference information allowing external copies of content items to be identified from external sources which may specifically be part of a peer-to-peer network. The reduced reference information may automatically be stored on recordable DVD disks when a content item is stored thereon. Following a hard disk malfunction or replacement, hard disk information may be restored in response to the reduced reference information.

The invention relates to a content item recorder and method of operation therefor in particular to back-up of content item storage means.

In recent years, the accessibility to, and provision of, information and content, such as TV programmes, video clips, music, email and electronic books etc have increased explosively. The information and content may today be provided from many different sources, and the variety and availability of content has increased substantially.

For example, the number of available television channels in most countries has increased substantially over the last decade. In many countries, viewers can receive tens or even hundreds of different TV channels. The TV channels are further provided from different broadcasters and sources, and are communicated through a variety of media including digital terrestrial broadcasts, cable distribution or satellite broadcasts. Similarly, the number of available radio channels has increased explosively and are provided through different media such as satellite broadcasts, terrestrial radio broadcasts, cable distribution or even through the Internet.

In addition, available facilities for electronically storing content items have increased substantially. For example, digital video recording equipment has become increasingly prevalent and has reduced significantly in price. These new video recording devices typically comprise functionality aimed at assisting the user in selecting, recording and organising recorded content items.

An example of consumer equipment for storage of audiovisual content items is a DVD (Digital Versatile Disc) recorder, which has recently been introduced to the consumer market. A DVD recorder allows a user to record one or more content items on a recordable DVD medium. Typically, DVD recorders comprise means for selecting, recording, editing and organising the audiovisual signals being stored. For example, a plurality of items may be recorded on a DVD. Thus a recorded DVD may for example comprise received TV programmes or films as well as video footage and photos from a digital camera. Thus, a user may mix different content from different sources. Typically, several hours of audiovisual signals may be recorded on a single DVD medium, and therefore many DVDs will comprise a plurality of different items.

Another example of consumer equipment for storage of audiovisual signals is Personal Video Recorders (PVRs), which typically record audiovisual signals on a permanent hard disk rather than on a removable recordable medium. PVRs typically comprise hard disks of sufficient size to record several tens of hours of video footage thereby allowing a high number of e.g. TV programmes to be stored on the hard disk.

Both PVRs and DVD recorders tend to be provided with features that facilitate the user in identifying and selecting suitable content items for recording. For example, a PVR may comprise means for building up a user profile of the user's preferences and for automatically finding and recording content items that matches this user profile.

The recording capability of a PVR is generally limited by the size of the incorporated hard disk. In order to store sufficient amounts of content, the hard disks tend to be large and currently are typically from 20 Gigabyte to 120 Gigabyte although this is expected to increase significantly in the future.

Reliability of consumer equipment is of high importance in order to achieve high customer satisfaction. However, hard disks may malfunction and therefore the use of hard disks results in a critical failure risk for a PVR. The problem is exacerbated by the fact that a hard disk in a PVR typically is active for long durations, potentially semi-permanently. Furthermore, the lifetime of consumer equipment is expected to be significantly longer than for a conventional use of a hard disk in a computer thereby increasing the probability of a failure over the lifetime of the consumer equipment.

Furthermore, the malfunction of a hard disk is very critical in a PVR as the hard disk not only stores the individual content items but also stores user or device specific information. For example, the user profile is typically stored on the hard disk.

A known approach for mitigating the effect of hard disk failures in the field of computers is to create and store a back-up copy of the hard disk. However, due to the large size of the hard disk in a PVR it is not practical to back up the hard disk as this would result in very large back-up files and thus in high storage requirements and a cumbersome and time consuming back up processes. For example, around 25 standard recordable DVDs (having a capacity of 4.7 Gigabyte) are required to store a back-up of a 120 GB hard disk.

Hence, an improved content item recorder would be advantageous and in particular a content item recorder facilitating or improving failure recovery, reducing the impact of a hard disk malfunction, reducing storage requirements, facilitating user operation, allowing for increased flexibility and/or allowing for improved failure performance would be advantageous.

Accordingly, the Invention preferably seeks to mitigate, alleviate or eliminate one or more of the above mentioned disadvantages singly or in any combination.

According to a first aspect of the invention, there is provided a content item recorder comprising: storage means for storing a plurality of content items; means for generating reduced reference information associated with the plurality of content items; and means for storing the reduced reference information to a back-up memory separate from the storage means.

The invention thus allows for a back-up means for a content item recorder wherein only reduced reference information needs to be stored thereby allowing for a significantly reduced storage requirements and reduced back-up process duration. The invention may allow for a partial back-up to be performed on back-up memory which is substantially smaller than the storage means.

Thus the invention may allow for an efficient back-up process where only limited information needs to be backed up thus resulting in the possibility of using back-up memory types otherwise precluded. For example, back up memory based on removable medium, such as a recordable optical disc, or flash memory may be used. Furthermore, the time consumption and complexity of a back up is significantly reduced. Hence, the invention may allow for a flexible, efficient and/or practical back-up for content item recorders.

The reduced reference information may comprise information directly or indirectly related to the content items, which are or have been stored in the storage means but does not include the content data of the content items themselves. The reduced reference information may for example comprise references to content items allowing these to be accessed from other means. Preferably, the reduced reference information comprises information allowing the storage means (or alternative storage means) to be initialised to a state identical or similar to that of the storage means at the time of the back up of the reduced reference information to the back-up memory.

The back-up memory is separate from the storage means and may be external or internal to the content item recorder. The plurality of content items to which the reduced reference information may be associated to may include content items currently stored and/or content items previously stored in the storage means.

The storage means may specifically be a hard disk.

According to a feature of the invention, the reduced reference information comprises an information subset of a user profile associated with the plurality of content items.

The reduced reference information may comprise or may specifically consist in an information subset of a user profile. The information subset may directly correspond to an extract of a stored user profile or may be derived by processing of information of a user profile.

Hence, the invention may allow for a simple and low resource demanding back-up of user profile information allowing for the storage means (or alternative storage means) to be initialised with a current user profile which matches a user. As a user profile is built up over a long duration and improves with time, the potential for initialising other storage means with an existing user profile allows for a significantly reduced inconvenience to a user in case of storage means malfunction.

According to a different feature of the invention, the means for generating is operable to select information of the user profile for the information subset in response to a user profile detail level associated with the information.

This allows for a convenient method of reducing storage requirements for the reduced reference information. For example, a user profile may typically comprise information of increasing detail and refinement By excluding information which is very detailed significant reductions in the size of the reduced reference information may be achieved while ensuring that a restored user profile only deviates little from the original.

According to a different feature of the invention, the means for generating is operable to select information of the user profile for the information subset in response to a user profile certainty level associated with the information.

This allows for a convenient method of reducing storage requirements for the reduced reference information. For example, a user profile may determine preference information depending on matches between selected content items and categories and the confidence level may depend on the number of matches detected. By excluding information which has a low confidence value, the size of the reduced reference information may be reduced while ensuring that a restored user profile only deviates little from the original.

According to a different feature of the invention, the content item recorder further comprises first recording means for recording content items to a removable medium and second recording means for recording the reduced reference information to the removable medium.

This allows for a removable medium to be used both for storing content items and for storing the reduced reference information for back-up. Hence, no external or additional back-up memory is needed.

The first and second recording means may be partially or fully the same. For example, a single disk drive and disk drive controller may be used for recording of both content items and the reduced reference information.

According to a different feature of the invention, the second recording means are operable to automatically record the reduced reference information to the removable medium in response to the first recording means recording a content item to the removable medium.

Specifically, the content item recorder may automatically record reduced reference information to a recording medium when a user records a content item. This allows for an automatic back-up file being stored without any requirement for involvement by or inconvenience to the user. Indeed the user need not know that back-up information is created on the user's medium. Due to the low size of the reduced reference information, the reduction of available recording capacity and increased recording time will typically be insignificant.

According to a different feature of the invention, the content item recorder comprises means for determining if a removable medium comprises recorded reduced reference information and to automatically record the reduced reference information to the removable medium if the removable medium does not comprise recorded reduced reference information.

This allows for the content item recorder to automatically add reduced reference information to recordable mediums, which do not comprise one.

According to a different feature of the invention, the reduced reference information further comprises removable medium catalogue information.

A content item recorder for removable media typically generates and stores a catalogue of recorded media facilitating a user in finding a specific recorded content item. Including the removable medium catalogue information in the reduced reference information allows for the catalogue to be restored following a storage means failure.

According to a different feature of the invention, the removable medium is a recordable Digital Versatile Disc (DVD). This is a particularly suitable removable medium.

According to a different feature of the invention, the reduced reference information comprises identity information associated with content items currently stored in the storage means.

The identity information may specifically comprise sufficient information to partially or fully identify a content item. Hence, the identity information may allow the content item recorder to reference content items and specifically to e.g. search for and retrieve copies of content items referenced in the reduced reference information.

According to a different feature of the invention, the identity information comprises a title of at least one content item. This provides a suitable parameter for identifying and/or referencing content items.

According to a different feature of the invention, the identity information comprises a broadcast time of a broadcast programme content item. This provides a suitable parameter for identifying and/or referencing content items.

According to a different feature of the invention, the identity information comprises a broadcast channel identification of a broadcast programme content item. This provides a suitable parameter for identifying and/or referencing content items.

According to a different feature of the invention, the identity information comprises content item signature data of at least one content item. This provides a suitable parameter for identifying and/or referencing content items. The signature may specifically comprise or consist in a data sequence generated by applying a predetermined algorithm to content data of the content items.

According to a different feature of the invention, the reduced reference information comprises pointers to external copies of the content items of at least one of the plurality of content items.

This allows for a very efficient and low complexity way of identifying content items and locations from where these may be retrieved.

According to a different feature of the invention, the reduced reference information comprises content item access rights information.

For example, the access rights information may include information indicating the user's rights to copy or present specific content items. Hence, this may allow for a content item recorder, which can ensure that any restore operation based on the reduced reference information does not result in unallowable accessing or copying of content items.

According to a different feature of the invention, the content item recorder further comprises: means for entering a restore mode of operation; means for retrieving the reduced reference information from the back-up memory; means for retrieving content items in response to the reduced reference information from at least one external source; and means for storing the retrieved content items.

Hence, the content item recorder may be operable to partially or fully restore the storage means (or alternative storage means) to a state of the storage means when the reduced reference information was stored in the back-up memory. Hence, the content item recorder may restore a storage means from a back-up of reduced size thus allowing for a practical back-up process suitable for a content item recorder having large size storage medium.

Specifically, the content item recorder may restore a hard disk of a content item recorder by identifying, locating and retrieving as many content items as possible based on the information of the reduced reference information.

According to a different feature of the invention, the content item recorder comprises access means for accessing a network comprising the at least one source. Preferably the network is a peer-to-peer network.

This provides for a particularly suitable means of restoring a content item recorder. The network may specifically comprise a number of other content item recorders or storage devices which may independently, or in cooperation with the content item recorder, have stored copies of some or all of the content items.

Preferably, the content item recorder is a Personal Video Recorder (PVR).

According to a second aspect of the invention, there is provided a method of operation for a content item recorder having storage means for storing a plurality of content items, the method comprising the steps of: generating reduced reference information associated with the plurality of content items; and storing the reduced reference information to a back-up memory separate from the storage means.

These and other aspects, features and advantages of the invention will be apparent from and elucidated with reference to the embodiment(s) described hereinafter.

An embodiment of the invention will be described, by way of example only, with reference to the drawings, in which

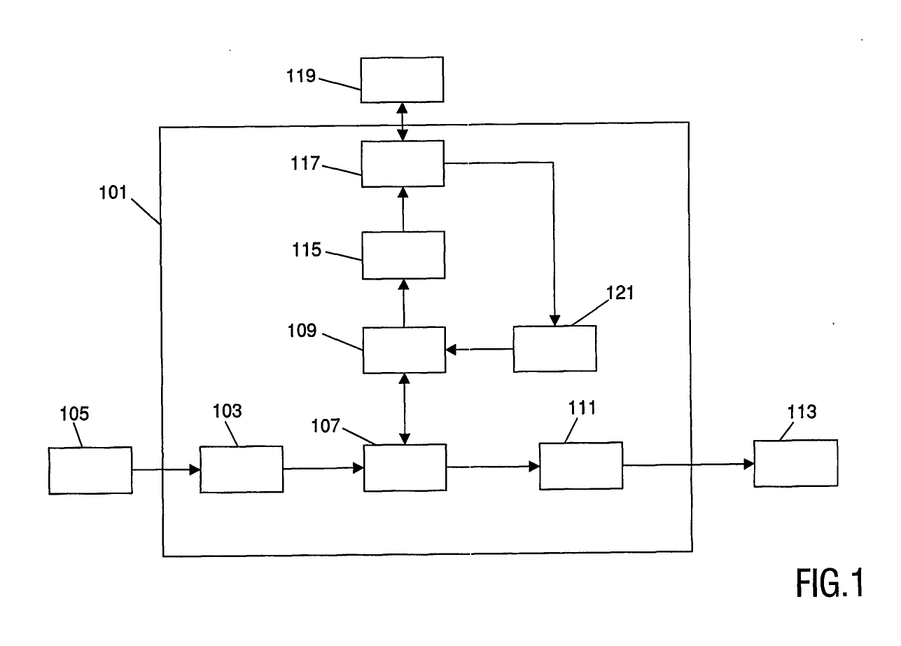

FIG. 1 illustrates a block diagram of a PVR in accordance with an embodiment of the invention.

The following description focuses on an embodiment of the invention applicable to a Personal Video Recorder (PVR). However, it will be appreciated that the invention is not limited to this application but may be applied to many other content item recorders.

FIG. 1 illustrates a block diagram of a PVR 101 in accordance with an embodiment of the invention.

The PVR 101 comprises a receiver 103 for receiving content items from an external source 105. In the preferred embodiment, the external source 105 may be a TV transmitter and the receiver 103 may be a suitable TV tuner for receiving TV broadcasts. In other embodiments other sources and receiving means may be used. For example, the receiver may be a network interface and the external source may be another network element in the network to which the PVR is connected. In other embodiments, the content item source may be an internal source.

The receiver 103 is coupled to a content item processor 107, which is operable to process the content items received by the receiver 103. The content item processor 107 is coupled to storage means, which specifically is a hard disk 109 of sufficient size to store a suitable amount of content items.

The content item processor 107 is furthermore coupled to a display processor 111, which is operable to receive content items from the content item processor 107 and to generate a suitable display signal. The display processor 111 is coupled to an external display 113 where the presentation signal from the display processor 111 may be displayed. The display 113 may specifically be a suitable video monitor or TV.

The content item processor 107 is operable to select content items received by the receiver 103 and to store them on the hard disk 109. The content item processor 107 may select the content items in response to a specific user input. However, in addition the content item processor 107 may automatically instigate recording of content items.

Specifically, the content item processor may generate a user profile comprising information of the user preference for different types and categories of content items. The content item processor 107 may monitor characteristics of content items selected by the user and assign an increasing preference value to content items categories, which are frequently selected by the user. During idle operation, the PVR may monitor for content items matching categories of content items having high preference values and automatically record these to the hard disk 109.

Thus, the content item processor 107 may generate a detailed user profile, which accurately reflects the user's preferences. It will be appreciated that any suitable algorithm or approach for determining a user profile or preference indications may be used. The content item processor 107 stores the generated user profile on the hard disk 109. The user profile may be very detailed and accordingly may be of a significant size.

In the preferred embodiment, the content items correspond to TV programmes or sections of TV programmes but it will be appreciated that the invention is not limited to this application but is equally applicable to other content item types or to any suitable combination of content items. For example, in other embodiments content items may include movies, audio clips, radio programmes, images, text documents etc.

The PVR 101 furthermore comprises a back-up processor 115 coupled to the hard disk 109. The back-up processor 115 is operable to generate reduced reference information associated with the content items that are or have been stored on the hard disk 109.

The back-up processor 115 is furthermore coupled to a memory interface 117 which is operable to interface to a back-up memory 119. The back-up processor 115 is through the memory interface 117 operable to store the reduced reference information in the back-up memory 119. The back-up memory 119 may be any suitable memory including for example an external removable medium such as a recordable magneto and/or optical disk and internal or external flash memory. The memory interface 117 may be any suitable interface for interfacing to the back-up memory 119 including for example a disk drive, network interface or a flash memory interface.

The PVR 101 further comprises a restore processor 121 coupled to the memory interface 117 and operable to retrieve the reduced reference information from the back-up memory 119. The restore processor 121 is furthermore operable to restore information on the hard disk 109 in response to the retrieved reduced reference information.

Hence, the PVR 101 comprises functionality for generating reduced reference information, which can be used for restoring information on the hard disk 109 following a hard disk failure. In the preferred embodiment, the PVR 101 furthermore comprises the functionality for restoring the information from the reduced reference information. The reduced reference information may be one or more magnitudes smaller than the corresponding information stored on the hard disk and thus the storage requirements for the back-up memory is significantly reduced thereby allowing back-up to be performed on back-up memory incapable of containing a full hard disk back-up file.

In a first example embodiment, the reduced reference information comprises or consists in an information subset of a user profile associated with the plurality of content items.

In this embodiment, the back-up processor 115 is operable to retrieve the user profile from the hard disk 109. The back-up processor 115 then generates reduced user profile information and stores this in the back-up memory 119 as the reduced reference information.

Preferably, the reduced user profile is generated as an extraction of the most important and reliable data from the user profile but it will be appreciated that any suitable approach or criterion for generating the reduced user profile may be used.

In the first example embodiment, the back-up processor 115 is operable to evaluate the data of the user profile with respect to a level of detail associated with the user profile. The back-up processor 115 then preferably selects information that has a low detail degree to be included in the reduced user profile and excludes the data below a certain level of detail.

For example, a user profile may comprise information that a user has a high preference for sport. At a lower detail level, the user profile may indicate that the preference is relatively high for football but relatively low for swimming. At a lower detail level yet, the user profile may reflect that the user has a higher preference for Dutch football matches, a slightly lower preference for English football matches and a low preference for German football matches. At yet a lower detail level, the user profile may indicate that the user prefers Dutch cup matches to Dutch league matches.

In such a case, the back-up processor 115 may select the higher levels of detail to be included in the reduced user profile and ignore the lower levels of detail. Thus, the back-up processor 115 may include the information related to the high preference for sports and specifically football but may exclude the information related to which nationality and type of games are preferred.

Employing this approach across the different categories of the user profile will result in a significantly reduced size user profile, which may conveniently be stored in back-up memory 119.

In the first example embodiment, the back-up processor 115 is furthermore operable to determine select information of the user profile in response to a user profile certainty level associated with the information.

A user profile may typically be determined in response to a user's actions and specifically to his selection of content items to view and record. Accordingly, as more and more information on a user's selections is gathered, the accuracy of preferences based on the selections increases. However, in order to continually update the user profile to reflect the variations in a user's preferences (or in available content), the user profile will still comprise information based on relatively few preferences. For example, new categories may be allocated a relatively high preference value based on a few selections in order to result in more content items being suggested within this category. If this results in more selections, the preference value may increase further and otherwise the preference value may decrease. Hence, the PVR may include relatively uncertain preference values used to test the user's preference. These will have a high uncertainty as they are based on few selections.

The back-up processor 115 may select the higher certainty preference information to be included in the reduced user profile and ignore the lower certainty values.

Hence, the reduced user profile stored in the back-up memory 119 is preferably of lower size than the user profile stored on the hard disk 109. However, preferably, the reduced user profile still corresponds to a consistent user profile which may be restored and used directly by the apparatus.

Preferably, the reduced user profile comprises the reliable less detailed information of the user profile. Accordingly, if the hard disk 109 malfunctions and the user profile is corrupted, inaccessible or a replacement hard disk is required, the reduced user profile may be restored on the hard disk 109. Although this does not correspond to an exact copy of the original user profile, the difference is typically insignificant as the most important and certain information is maintained. Furthermore, the more detailed and less reliable information omitted is that which can be regenerated fastest by the normal operation of the user profile processing of the PVR.

Hence, an efficient back-up process is achieved requiring only back-up of small amounts of information. This enables using back-up memory which would otherwise be impractical or impossible to use.

Specifically in the described embodiment, the back-up memory 119 is a removable medium such as DVD disk. In this case, the memory interface 117 may corresponds to a disk drive comprised in the PVR.

In this exemplary embodiment, the PVR is a combined hard disk and DVD recorder, i.e. content items may be stored on one or both of a hard disk and a DVD disk. The PVR furthermore comprises means for copying content items from the hard disk to the DVD disk. The DVD disk may for example be a DVD+R(W), a DVD-R(W) and/or a DVD-RAM.

In the example, the back-up processor 115 may thus additionally comprise functionality for controlling the PVR to record content items onto a recordable DVD disk. In addition, the back-up processor 115 is operable to record the reduced reference information onto a DVD disk on which content items are being recorded.

Preferably, the reduced reference information is recorded automatically onto the DVD disks whenever a new content item is recorded without any interaction or involvement by the user. Thus, the PVR automatically stores back-up information on DVD disks which can be used to restore information on the hard disk. Hence, the back-up generation may be completely transparent to the user and indeed performed without the user being made aware thereof. If a restore of information is required, the user may simply be requested to insert the last DVD disk recorded thereon, and the restore processor 121 may proceed to retrieve the reduced reference information and to restore the hard disk.

As the size of the reduced user profile may be very small, the reduction of recording capacity on the DVD disk is insignificant. For example, reduced user profile file sizes of 50 kbyte are possible which is insignificant in view of the 4.7 Gbyte storage capacity of standard recordable DVD disks.

In a slightly more complex embodiment, the PVR may be operable to read every new disk inserted for recording to determine if a reduced user profile has already been stored on the disk. In this embodiment, a new reduced user profile may only be stored if the DVD disk does not already comprise a reduced user profile thereby saving space on the DVD disk.

Additionally or alternatively, if the DVD disk does contain reduced reference information that information may also be updated by newer (more up to date) reduced reference information.

Typically, removable media recorders such as DVD recorders comprise functionality for generating a catalogue of DVD disks that have been recorded. In some embodiments, the reduced reference information may comprise catalogue information. Thus, in this embodiment, catalogues of recorded DVD disks may be conveniently backed up and restored following a hard disk malfunction.

In some embodiments, a dedicated recovery disk may be created. This disk may specifically contain all the information required for a recovery. The recorder may ask the user from time to time to insert the recovery disk, allowing the recorder to update the data thereon. The recovery disc is preferably included in the catalogue information.

In some embodiments, the reduced reference information may further comprise e.g. the titles of the content items of the hard disk. These titles (and other stored information about the recordings) may be used to increase the level of detail of the users profile. Also the catalogue information may be used for this purpose. This will result in a restored user profile that fits better to the user.

In a second exemplary embodiment, the reduced reference information additionally or alternatively comprises information that allows content items to be restored from other sources. In the described embodiment, the reduced reference information comprises information for content items, which allows the content item to be identified and alternatively or additionally comprises a pointer to a copy of the content item. Preferably, the reduced reference information comprises such information for all content items stored (or perhaps recently deleted) but in some embodiments, information related only to a subset of content items may be included.

The reduced reference information is thus of very limited size and specifically may be much smaller than the size of the corresponding content items. Accordingly, it may conveniently be stored in suitable low capacity back-up memories as previously described.

If a malfunction occurs in the hard disk and it is desirable or necessary to reinitialise it, the reduced reference information may be used. For example, if a hard disk is replaced by a replacement hard disk in order to increase storage capacity or because the original is faulty, the reduced reference information may be used to re-initialise the hard disk with content items that were stored on the original hard disk.

Specifically, the restore processor 121 may read the reduced reference information from the back-up memory 119. It may then for each content item determine suitable information that may be used to locate and retrieve the content item from an external source.

As a specific example, a number of content items may have been stored on DVD disks and the reduced reference information may comprise a pointer identifying a disk on which a specific content item is stored. In response to this reduced reference information, the restore processor 121 may request that the user inserts the specific DVD disk and the restore processor 121 may proceed to copy the content item from the DVD disk to the replacement hard disk.

Thus in the embodiment, content items may be restored in response to reduced reference information which does not comprise any content data. Hence, a full or partial back-up of content items of a hard disk can be achieved by a back-up file one or more orders of magnitude smaller than the file size of the content items.

Preferably, the PVR is connected to a network, which specifically may be a peer-to-peer network. In this case, the restore processor 121 may be operable to search the network to find other copies of the content items stored on other network elements. For example, if a peer-to-peer network of PVRs exists, a TV programme may be restored to the hard disk of the PVR by the restore processor 121 sending out a search request. PVRs of the network may in response to receiving the search request determine if they have recorded a copy of the TV programme, and if so, may send the corresponding content item to the PVR. Thus, a PVR may restore all or some of the lost content items by automatically downloading them from other network elements.

It will be appreciated that content items may be retrieved from other external sources including for example from Internet sites or from repeat broadcasts.

For example, a content item may have been recorded on the hard disk. If the hard disk crashes, this may be replaced by a new hard disk and the reduced reference information from the back-up memory may be used to initiate the new hard disk. If the apparatus is not able to retrieve the content item from another network element, it may add the content item to a list of programmes to record when they are broadcast. If the content item is subsequently broadcast on any channel that can be received by the PVR, it will be recorded automatically. As such the original situation of the failed hard disk will gradually be restored over time as more repeat broadcast occur.

Hence, the embodiment allows for a restore operation of content items based only on reference information rather than on back-up of the content items. Thus, the reduced reference information is used to recover data through e.g. peer-to-peer connections or the Internet. In another embodiment of the invention, the data for recovery is provided by the content provider or content providers, either for free or in return for payment of a fee. A complete recovery of the situation prior to a malfunction or replacement cannot be guaranteed but this is typically an acceptable consequence in view of the substantial reduction in storage requirements for the back-up file.

It will be appreciated that various types of information can be used for the reduced reference information.

For example, the reduced reference information may for some or all content items comprise a specific pointer identifying a specific location from where the content item can be retrieved. The specific location may for example be a specific Internet site or IP (Internet Protocol) address. The location may furthermore be a public or a private address and may specifically be a location within a private home network. For example, a home network may comprise a PVR and a personal computer where copies of some content items are known to be stored. This is particularly advantageous for user generated content items such as photos or home video content items.

In some embodiments, reduced reference information may for some or all content items comprise information which is particularly suitable for searching for copies of content items. For example, information for a content item may comprise a title of the content item. For example, if a content item corresponds to a song, the reduced reference information for that content item may comprise the title of the song thereby facilitating a search for the content item.

If the content item is a content item that has been received from a broadcast, such as for example a TV programme received from a TV broadcast, the reduced reference information may comprise a broadcast time and channel for that content item. This will allow a copy of the content item to be found by searching external devices to see if they have stored a broadcast of that channel and time.

Other possible information includes a content reference identity which may be transmitted by some broadcast stations. Furthermore, a signature may be generated for a content item according to a specific signature algorithm. The signature may be stored in the reduced reference information and during a restore operation, external sources may be searched for content items having a matching signature. Thus, preferably all or at least some external sources use the same signature algorithm. Thus may be particularly suitable for user specific content items. For example, if a photo is stored on a PVR and a personal computer, these may use the same algorithm to independently determine signatures for the content item. If the personal computer receives a request for a content item having a specific signature, it may search the signatures of the stored photos to determine if there is a match and if so may transmit the content item to the PVR.

In some embodiments, the reduced reference information may furthermore comprise content item access rights information. For example, the content items may correspond to content items which have been specifically purchased by the user (such as for example song files). Such content items may not be freely available and therefore will not be transmitted to the PVR unless the reduced reference information indicates that the user has attained the rights for such a copying.

The invention can be implemented in any suitable form including hardware, software, firmware or any combination of these. However, preferably, the invention is implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with the preferred embodiment, it is not intended to be limited to the specific form set forth herein. Rather, the scope of the present invention is limited only by the accompanying claims. In the claims, the term comprising does not exclude the presence of other elements or steps. Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is no feasible and/or advantageous. In addition, singular references do not exclude a plurality. Thus references to “a”, “an”, “first”, “second” etc do not preclude a plurality.

In summary, the invention relates to a content item recorder (101) comprising storage means (109) for storing a plurality of content items. The content item recorder (101) may be a Personal Video Recorder (PVR) comprising a hard disk. The content item recorder (109) comprises a back-up processor (115) generating reduced reference information associated with the plurality of content items; and a memory interface (117) for storing the reduced reference information to a back-up memory (119) separate from the storage means (109). The reduced reference information may be reduced user profile information of reference information allowing external copies of content items to be identified from external sources which may specifically be part of a peer-to-peer network. The reduced reference information may automatically be stored on recordable DVD disks when a content item is stored thereon. Following a hard disk malfunction or replacement, hard disk information may be restored in response to the reduced reference information. For example, the reduced reference information may be used to search elements of a network for copies of content items.

1. A content item recorder (101) comprising:
storage means (109) for storing a plurality of content items;
means (115) for generating reduced reference information associated with the plurality of content items; and
means (117) for storing the reduced reference information to a back-up memory (119) separate from the storage means (109).

2. A content item recorder as claimed in claim 1 wherein the reduced reference information comprises an information subset of a user profile associated with the plurality of content items.

3. A content item recorder as claimed in claim 1 wherein the means (115) for generating is operable to select information subset of a user profile associated with the plurality of response to a user profile detail level associated with the information.

4. A content item recorder as claimed in claim 1 wherein the means (115) for generating is operable to select information of the user profile for the information subset in response to a user profile certainty level associated with the information.

5. A content item recorder as claimed in claim 1 further comprising first recording means (117, 115) for recording content items to a removable medium and second recording means (117, 115) for recording the reduced reference information to the removable medium.

6. A content item recorder as claimed in claim 5 wherein the second recording means (117, 115) is operable to automatically record the reduced reference information to the removable medium in response to the first recording means (117, 115) recording a content item to the removable medium.

7. A content item recorder as claimed in claim 6 further comprising means for determining whether a removable medium comprises recorded reduced reference information and to automatically record the reduced reference information to the removable medium if the removable medium does not comprise recorded reduced reference information.

8. A content item recorder as claimed in claim 5 wherein the reduced reference information further comprises removable medium catalogue information.

9. A content item recorder as claimed in claim 5 wherein the removable medium is a recordable Digital Versatile Disc (DVD).

10. A content item recorder as claimed in claim 1 wherein the reduced reference information comprises identity information associated with content items currently stored in the storage means.

11. A content item recorder as claimed in claim 10 wherein the identity information comprises a title of at least one content item.

12. A content item recorder as claimed in claim 10 wherein the identity information comprises a broadcast time of a broadcast programme content item.

13. A content item recorder as claimed in claim 10 wherein the identity information comprises a broadcast channel identification of a broadcast programme content item.

14. A content item recorder as claimed in claim 10 wherein the identity information comprises content item signature data of at least one content item.

15. A content item recorder as claimed in claim 1 wherein the reduced reference information comprises pointers to external copies of the content items of at least one of the plurality of content items.

16. A content item recorder as claimed in claim 1 wherein the reduced reference information comprises content item access rights information.

17. A content item recorder as claimed in claim 1 further comprising
means (121) for entering a restore mode of operation; means (121, 117) for retrieving the reduced reference information from the back-up memory;
means (121) for retrieving content items in response to the reduced reference information from at least one external source; and
means (121) for storing the retrieved content items.

18. A content item recorder as claimed in claim 17 further comprising access means for accessing a network comprising the at least one source.

19. A content item recorder as claimed in claim 18 wherein the network is a peer-to-peer network.

20. A content item recorder as claimed in claim 1 wherein the content item recorder is a Personal Video Recorder (PVR).

21. A method of operation for a content item recorder (101) having storage means (109) for storing a plurality of content items, the method comprising the steps of:
generating reduced reference information associated with the plurality of content items; and
storing the reduced reference information to a back-up memory separate from the storage means.

22. A method of operation for a content item recorder as claimed in claim 21 further comprising the steps of:
entering a restore mode of operation; retrieving the reduced reference information from the back-up memory;
retrieving content items in response to the reduced reference information from at least one external source; and
storing the retrieved content items.

23. A computer program enabling the carrying out of a method according to claim 22.

24. A record carrier comprising a computer program as claimed in claim 23.
